(19) United States
(12) Patent Application Publication
(10) Pub. No.: US 2026/0196965 A1
(43) Pub. Date: Jul. 9, 2026

(54) PULL-OUT SOLAR PANEL-EQUIPPED ROOF RACK

(71) Applicant: Guangzhou Issyzone Technology Co.,Limited, Guangzhou (CN)

(72) Inventors: ZHUO JIA, Guangzhou City (CN); TAIPING YANG, Guangzhou City (CN)

(21) Appl. No.: 19/031,802

(22) Filed: Jan. 18, 2025

(30) Foreign Application Priority Data
Jan. 9, 2025 (CN) 202520047842.6

(51) Int. Cl. H02S 30/20; B60R 9/04; B60R 11/00; H02S 20/30

(52) U.S. Cl. CPC H02S 30/20; B60R 9/04; H02S 20/30; B60R 11/00; B60R 2011/004; B60R 2011/0064; B60R 2011/0082; B60R 2011/0084

(57) ABSTRACT

A pull-out solar panel-equipped roof rack according to the present invention includes: a base fixed on a roof of a target vehicle; rail mounting bases respectively mounted on two ends of the base; a storage rack mounted on top ends of the rail mounting bases. The present invention has the following beneficial effects: A pair of rail mounting bases are provided, the solar panel is hidden in the rail mounting bases through the slide rail, and the storage rack is mounted on the top ends of the rail mounting bases; when a user needs solar power generation, the solar panel is pulled out from the rail mounting base, so that the solar panel does not need to occupy a storage space of the storage rack during mounting.

### CROSS REFERENCE TO RELATED APPLICATIONS

The present application claims the priority of Chinese patent application No. 202520047842.6, filed on Jan. 9, 2025, and contents of which are incorporated herein by reference.

### BACKGROUND OF THE INVENTION

### Field of the Invention

The present invention belongs to the technical field of vehicle accessories, and in particular, relates to a pull-out solar panel-equipped roof rack.

### Description of Related Art

In order to solve the problem of electricity consumption in the wild, mounting a solar panel on a vehicle roof is a common solution. Existing solar panels require a rack as a mounting base. However, the mounting method requires first removing a piece of luggage on the vehicle roof and then mounting the solar panel on the rack, such as a vehicle roof trunk disclosed in CN109131122A. The above mounting structure requires users to frequently pick up and put down the luggage, and the solar panel also needs to be mounted and disassembled at a high height, which is neither convenient nor safe.

### SUMMARY OF THE INVENTION

In view of the above problem, the present invention provides a pull-out solar panel-equipped roof rack, which mainly solves the problem that the existing solar panel needs to occupy a storage space of a roof rack during mounting.

In order to solve the above technical problems, the technical solution of the present invention is as follows:
a pull-out solar panel-equipped roof rack, including:
a base configured to be fixed on a roof of a target vehicle;
rail mounting bases respectively mounted on two ends of the base;
a storage rack mounted on top ends of the rail mounting bases;
a slide rail having a rail end mounted on an inner side of the corresponding rail mounting base; and
a solar panel having two ends respectively connected to slider ends of the slide rail.

In some embodiments, the base includes at least two support rods, a roof cross bar, and a clamp connecting the roof cross bar to bottoms of the support rods, the two support rods are provided parallel to each other, and two ends of each of the support rods are fixedly connected to the rail mounting bases respectively.

In some embodiments, a surface of the support rod is provided with first fixing holes evenly distributed along a length direction of the support rod, and the clamp is fixed to the support rod through the first fixing holes.

In some embodiments, the pull-out solar panel-equipped roof rack further includes at least two connecting plates, in which two ends of each of the connecting plates are respectively connected to the slider ends of the slide rail, and the solar panel is disposed at upper ends of the connecting plates.

In some embodiments, a surface of the connecting plate is provided with second fixing holes evenly distributed along a length direction of the connecting plate, and a bottom of the solar panel is fixed to the connecting plate through the second fixing holes.

In some embodiments, an upper end of the slider end of the slide rail is provided with an extension, a center of the extension is provided with a locking hole, and an upper end surface of the rail mounting base is provided with a locking member matching with the locking hole.

The present invention has the following beneficial effects: a pair of rail mounting bases are provided, the solar panel is hidden in the rail mounting bases through the slide rail, and the storage rack is mounted on the top ends of the rail mounting bases; when a user needs solar power generation, the solar panel is pulled out from the rail mounting base, so that the solar panel does not need to occupy a storage space of the storage rack during mounting.

### BRIEF DESCRIPTION OF THE DRAWINGS

FIG. 1 is a schematic diagram of a storage state of a pull-out solar panel-equipped roof rack disclosed in an embodiment of the present invention.

FIG. 2 is a first schematic diagram of an unfolded state of the pull-out solar panel-equipped roof rack disclosed in an embodiment of the present invention.

FIG. 3 is a second schematic diagram of an unfolded state of the pull-out solar panel-equipped roof rack disclosed in an embodiment of the present invention.

FIG. 4 is a partial schematic diagram of a longitudinal section of the pull-out solar panel-equipped roof rack disclosed in an embodiment of the present invention.

### REFERENCE SIGNS LIST

1: base; 2: rail mounting base; 3: storage rack; 4: slide rail; 5: solar panel; 101: support rod; 102: roof cross bar; 103: clamp; 104: first fixing hole; 201: locking member; 401: connecting plate; 402: second fixing hole; 403:
extension; 404: locking hole

### DETAILED DESCRIPTION OF THE INVENTION

To make an object, technical solutions, and advantages of the present invention clearer and more specific, the content of the present invention will be further described in detail in combination with the drawings and embodiment. It is understood that the embodiment described here is merely used to describe the present invention, not to limit the present invention. It should be noted that, for the convenience of description, only parts related to the present invention are shown in the drawings, rather than all of the content.

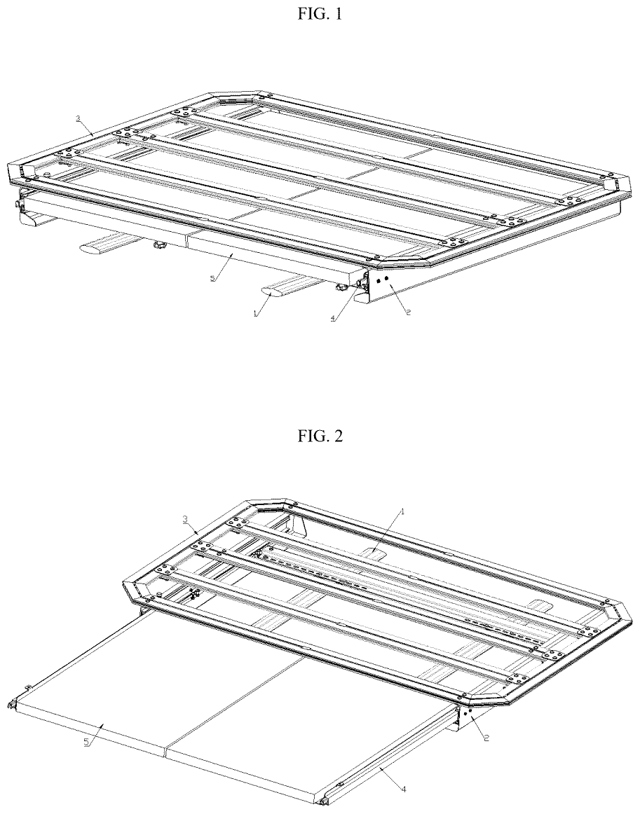

The present embodiment provides a pull-out solar panel-equipped roof rack, as shown in FIG. 1, including:
a base 1 fixed on a roof of a target vehicle;
rail mounting bases 2 respectively mounted on two ends of the base 1;
a storage rack 3 mounted on top ends of the rail mounting bases 2;
a slide rail 4 having a rail end mounted on an inner side of the corresponding rail mounting base 2; and
a solar panel 5 having two ends respectively connected to slider ends of the slide rail 4.

In this solution, the pair of rail mounting bases 2 are provided, the solar panel 5 is hidden in the rail mounting bases 2 through the slide rail 4, and the storage rack 3 is mounted on the top ends of the rail mounting bases 2; when a user needs solar power generation, the solar panel 5 is pulled out from the rail mounting base 2, so that the solar panel 5 does not need to occupy a storage space of the storage rack 3 during mounting. The solar panel 5 in the device is unfolded as shown in FIG. 2.

In the present embodiment, the base 1 serves as an intermediate connection structure for mounting the rail mounting base 2 to a roof of a target vehicle, and the structure thereof may be various. In an example, the base 1 includes at least two support rods 101, a roof cross bar 102, and a clamp 103 connecting the roof cross bar 102 to bottoms of the support rods 101, the two support rods 101 are provided parallel to each other, and two ends of each of the support rods 101 are fixedly connected to the rail mounting base 2 respectively. In the example, it is assumed that the target vehicle has its own rack, first, the roof cross bar 102 is mounted on the rack of the target vehicle (a mounting method of the roof cross bar 102 is a prior art and will not be described in detail here), and then the two support rods 101 are fixed to the roof cross bar 102 using the clamp 103, and finally the two rail mounting bases 2 are mounted on both ends of the two support rods 101 to form a rectangular frame.

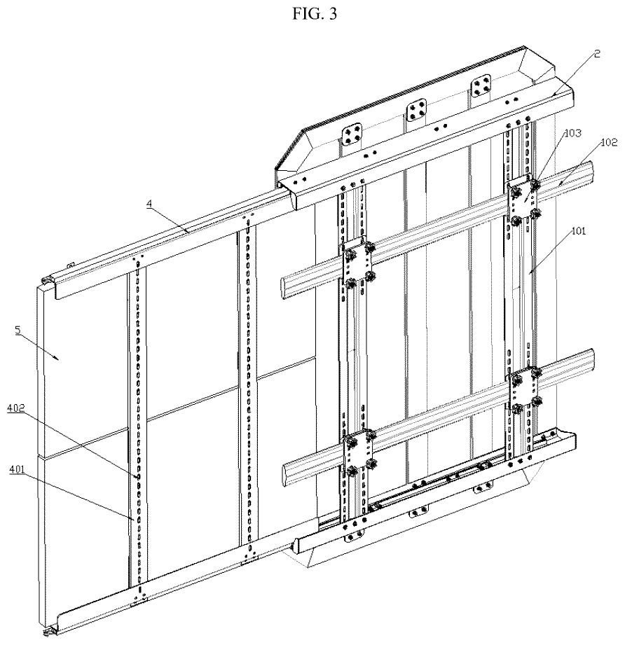

Since distances between the roof cross bars 102 mounted on different vehicle models are different, a preferred solution is provided. Specifically, as shown in FIG. 3, a surface of the support rod 101 is provided with first fixing holes 104 evenly distributed along a length direction of the support rod 101, and the clamp 103 is fixed to the support rod 101 through the first fixing holes 104. In this solution, the plurality of first fixing holes 104 are provided on the surface of the support rod 101. A user aligns the clamp 103 with the first fixing holes 104 at a suitable position, and fixes the two support rods 101 on the roof cross bars 102 through the clamp 103. In principle, each support rod 101 should be placed in the middle of the two roof cross bars 102 to avoid unstable center of gravity of the entire base 1.

As another important invention point of the present invention, as shown in FIG. 3, the present invention further includes at least two connecting plates 401, two ends of each of the connecting plates 401 are respectively connected to the slider ends of the slide rail 4, and the solar panel 5 is disposed at upper ends of the connecting plates 401. In the preferred solution, each of the connecting plates 401 is used as an intermediate mounting structure, the solar panel 5 needs to be first mounted on the connecting plates 401, and then fixed with the slide rail 4 through the connecting plates 401, and through the connecting plates 401, the user can use a smaller size solar panel 5 as required, and combine a plurality of small size solar panels 5 into one large size solar panel 5, thereby reducing mounting difficulty.

Optionally, a surface of the connecting plate 401 is provided with second fixing holes 402 evenly distributed along a length direction of the connecting plate, and a bottom of the solar panel 5 is fixed to the connecting plate 401 through the second fixing holes 402. A function and a structure of the second fixing holes 402 in this optional solution may refer to the above first fixing holes 104, and the purpose is to consider that bottom mounting hole standards of different models of solar panels 5 are inconsistent, and the plurality of second fixing holes 402 can adapt to mounting tasks of more models of solar panels 5.

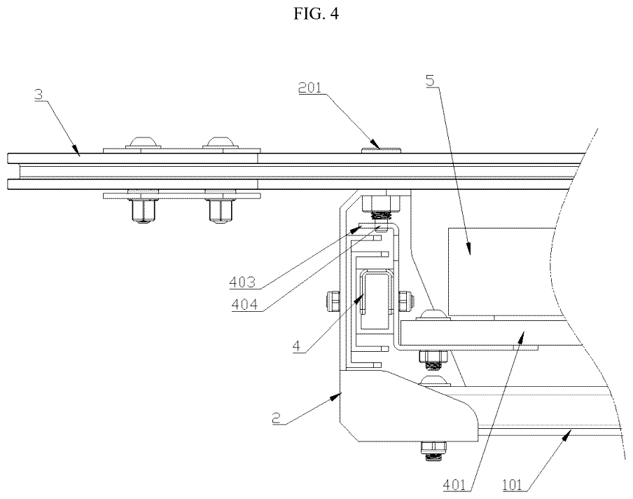

More preferably, as shown in FIG. 4, an upper end of the slider end of the slide rail 4 is provided with an extension 403, a center of the extension 403 is provided with a locking hole 404, and an upper end surface of the rail mounting base 2 is provided with a locking member 201 matching with the locking hole 404; in this solution, in order to ensure that the solar panel 5 is always fixed on the rail mounting base 2 during running of a vehicle, the upper end of the slider end of the slide rail 4 is provided with the extension 403, the center of the extension 403 is provided with the locking hole 404, and the upper end surface of the rail mounting base 2 is provided with the locking member 201; before the running of the vehicle, the solar panel 5 needs to be pushed into the rail mounting base 2 first, and then the locking member 201 is inserted into the locking hole 404 to fix the slide rail 4 and the solar panel 5 mounted on the slide rail 4. The locking member 201 may be a screw or a resettable elastic latch.

The above embodiment merely describes the technical concept and characteristics of the present invention, and is intended to enable those skilled in the art to understand the content of the present invention and implement the same, and not to limit the protection scope of the present invention. All equivalent changes or modifications made according to the substance of the content of the present invention should be included in the protection scope of the present invention.

What is claimed is:

1. A pull-out solar panel-equipped roof rack, comprising:
a base configured to be fixed on a roof of a target vehicle;
rail mounting bases respectively mounted on two ends of the base;
a storage rack mounted on top ends of the rail mounting bases;
a slide rail having a rail end mounted on an inner side of the corresponding rail mounting base; and
a solar panel having two ends respectively connected to slider ends of the slide rail.

2. The pull-out solar panel-equipped roof rack according to claim 1, wherein
the base includes at least two support rods, a roof cross bar, and a clamp connecting the roof cross bar to bottoms of the support rods, the two support rods are provided parallel to each other, and two ends of each of the support rods are fixedly connected to the rail mounting bases respectively.

3. The pull-out solar panel-equipped roof rack according to claim 2, wherein
a surface of the support rod is provided with first fixing holes evenly distributed along a length direction of the support rod, and the clamp is fixed to the support rod through the first fixing holes.

4. The pull-out solar panel-equipped roof rack according to claim 1, further comprising:
at least two connecting plates, wherein two ends of each of the connecting plates are respectively connected to the slider ends of the slide rail, and the solar panel is disposed at upper ends of the connecting plates.

5. The pull-out solar panel-equipped roof rack according to claim 4, wherein
a surface of the connecting plate is provided with second fixing holes evenly distributed along a length direction of the connecting plate, and a bottom of the solar panel is fixed to the connecting plate through the second fixing holes.

6. The pull-out solar panel-equipped roof rack according to claim 1, wherein
an upper end of the slider end of the slide rail is provided with an extension, a center of the extension is provided with a locking hole, and an upper end surface of the rail mounting base is provided with a locking member matching with the locking hole.
